(19) United States
(12) Patent Application Publication
(10) Pub. No.: US 2018/0181108 A1
(43) Pub. Date: Jun. 28, 2018

(54) NUMERICAL CONTROLLER AND MACHINE LEARNING DEVICE

(71) Applicant: FANUC Corporation, Yamanashi (JP)

(72) Inventor: Katsunori NAGANO, Yamanashi (JP)

(21) Appl. No.: 15/839,224

(22) Filed: Dec. 12, 2017

(30) Foreign Application Priority Data
Dec. 26, 2016 (JP) 2016-251899

(51) Int. Cl. G05B 19/408; G05B 13/02; G05B 19/18; G05B 19/19

(52) U.S. Cl. CPC G05B 19/4083; G05B 19/19; G05B 19/182; G05B 13/0265

(57) ABSTRACT

A numerical controller calculates a machining path based on a lathe turning cycle instruction and the settings of a machining path and machining conditions of the lathe turning cycle instruction. An evaluation value used to evaluate cycle time required for machining a workpiece performed according to the calculated machining path and the machining quality of the machined workpiece is calculated to perform machine learning of adjustment of the machining path and the machining conditions. By the machine learning, a machining path based on a complex lathe turning cycle instruction is optimized.

### BACKGROUND OF THE INVENTION

### 1. Field of the Invention

The present invention relates to a numerical controller and a machine learning device and, in particular, to a numerical controller and a machine learning device that perform machine learning to optimize a machining path based on a complex lathe turning cycle instruction.

### 2. Description of the Related Art

Numerical controllers for lathing have a turning cycle function by which an intermediate tool path during rough cutting is automatically determined according to a fixed rule only by programming a finishing shape (see, for example, Japanese Patent Application Laid-open No. 49-23385).

FIG. 8A shows the program of a turning cycle function, and FIG. 8B shows a machining example of a workpiece according to the program.

When a shape shown in FIG. 8A is machined, a program O1234 shown in FIG. 8B is generated and performed by the turning cycle function. In the program shown in FIG. 8B, a part composed of blocks N100 to N200 specifies a finishing shape.

In the program shown in FIG. 8B, an instruction “G71” is an instruction for a turning cycle operation. When the instruction is performed, an intermediate machining path is generated based on the finishing shape instructed by the program and a workpiece is cut out from a material based on the generated machining path. In a general turning cycle operation, a machining path successively machined from a pocket close to a start point toward an end point is generated as shown in FIG. 9.

By a turning cycle function, an operator is allowed to easily program an annoying turning operation.

When a specified finishing shape is a complicated shape (pocket shape) that may not be expressed by a simple increase or decrease, cycle time changes depending on a machining order or a cutting amount in a turning cycle. Since a machining path generated by a general turning cycle function is not generated in consideration of these elements, there arises a problem in that an optimum machining path is not necessarily generated in terms of cycle time. On the other hand, since the quality of a workpiece reduces when a feed rate or a cutting amount is easily increased in consideration of cycle time, it is necessary to improve the cycle time while maintaining the quality of the workpiece within a certain range.

### SUMMARY OF THE INVENTION

In view of the above circumstances, it is an object of the present invention to provide a numerical controller and a machine learning device that perform machine learning to optimize a machining path based on a complex lathe turning cycle instruction.

The preset invention employs machine learning to generate a machining path based on a finishing shape and machining conditions of a complex lathe turning cycle instruction given by a program to solve the above problem. When being given a finishing shape and machining conditions (a feed rate, a rotation number of a spindle, and a cutting amount) of a complex turning cycle by a program, an information processing apparatus according to the present invention outputs an intermediate machining path and machining conditions by which cycle time becomes the shortest while maintaining machining accuracy using a result of machine learning. A machining path generated by the information processing apparatus according to the present invention is output as the combination of a cutting feed block and a rapid traverse block to obtain a finishing shape.

A numerical controller according to an embodiment of the present invention controls a lathe machining machine based on a lathe turning cycle instruction instructed by a program to machine a workpiece. The numerical controller includes: a state information setting section in which a machining path and machining conditions of the lathe turning cycle instruction are set; a machining path calculation section that calculates the machining path based on setting of the state information setting section and the lathe turning cycle instruction; a numerical control section that controls the lathe machining machine according to the machining path, calculated by the machining path calculation section, to machine the workpiece; an operation evaluation section that calculates an evaluation value used to evaluate cycle time required for machining the workpiece performed according to the machining path calculated by the machining path calculation section and machining quality of the workpiece machined according to the machining path calculated by the machining path calculation section; and a machine learning device that performs machine learning of adjustment of the machining path and the machining conditions. The machine learning device has a state observation section that acquires the machining path and the machining conditions stored in the state information setting section and the evaluation value as state data, a reward conditions setting section that sets reward conditions, a reward calculation section that calculates a reward based on the state data and the reward conditions, an adjustment learning section that performs the machine learning of the adjustment of the machining path and the machining conditions, and an adjustment output section that determines an adjustment target and adjustment amounts of the machining path and the machining conditions as an adjustment action based on state data and a result of the machine learning of the adjustment of the machining path and the machining conditions by the adjustment learning section and adjusts the machining path and the machining conditions set in the state information setting section based on a result of the determination. The machining path calculation section recalculates and outputs the machining path based on the machining path and the machining conditions adjusted by the adjustment output section and set in the state information setting section. In addition, the adjustment learning section performs the machine learning of the adjustment of the machining path and the machining conditions based on the adjustment action, the state data acquired by the state observation section after the machining of the workpiece based on the machining path recalculated by the machining path calculation section, and the reward calculated by the reward calculation section based on the state data.

The numerical controller may further include: a learning result storage section that stores the result of the machine learning of the adjustment by the adjustment learning section. The adjustment output section may adjust the machining path and the machining conditions based on the result of the learning of the machining path and the machining conditions by the adjustment learning section and the result of the learning of the machining path and the machining conditions stored in the learning result storage section.

The reward conditions may be set such that a positive reward is provided when the cycle time decreases, the cycle time does not change, or the machining quality is within a proper range, and a negative reward is provided when the cycle time increases or the machining quality is outside the proper range.

The numerical controller may be connected to at least one of other numerical controllers and mutually exchange or share the result of the machine learning with the at least one of other numerical controllers.

A machine learning device according to another embodiment of the present invention performs machine learning of adjustment of a machining path and machining conditions of a lathe turning cycle instruction when controlling a lathe machining machine based on the lathe turning cycle instruction instructed by a program to machine a workpiece. The machine learning device includes: a state observation section that acquires the machining path and the machining conditions as state data; a reward conditions setting section that sets reward conditions; a reward calculation section that calculates a reward based on the state data and the reward conditions; an adjustment learning section that performs the machine learning of the adjustment of the machining path and the machining conditions; and an adjustment output section that determines an adjustment target and adjustment amounts of the machining path and the machining conditions as an adjustment action based on state data and a result of the machine learning of the adjustment of the machining path and the machining conditions by the adjustment learning section and adjusts the machining path and the machining conditions based on a result of the determination. The adjustment learning section performs the machine learning of the adjustment of the machining path and the machining conditions based on the adjustment action, the state data acquired by the state observation section after the machining of the workpiece based on the machining path recalculated after the adjustment action, and the reward calculated by the reward calculation section based on the state data.

According to an embodiment of the present invention, it becomes possible to generate a machining path by which cycle time becomes the shortest while maintaining prescribed machining accuracy in turning cycle machining and expect a reduction in the cycle time. As a result, it becomes possible to contribute to an improvement in productivity.

### BRIEF DESCRIPTION OF THE DRAWINGS

FIG. 1 is a diagram for describing the basic concept of a reinforcement learning algorithm;

FIG. 2 is a schematic diagram showing a neuron model;

FIG. 3 is a schematic diagram showing a neural network having weights of three layers;

FIG. 4 is an image diagram on the machine learning of a numerical controller according to an embodiment of the present invention;

FIG. 5 is a diagram for describing the definition of a machining path according to the embodiment of the present invention;

FIG. 6 is a schematic function block diagram of the numerical controller according to the embodiment of the present invention;

FIG. 7 is a flowchart showing the flow of the machine learning according to the embodiment of the present invention;

FIGS. 8A and 8B are diagrams for describing a turning cycle function; and

FIG. 9 is a diagram for describing a machining path generated by the turning cycle function.

### DETAILED DESCRIPTION OF THE PREFERRED EMBODIMENTS

In the present invention, a machine learning device serving as artificial intelligence is introduced into a numerical controller used to control a lathe machining machine that machines a workpiece. When being given a finishing shape and initial machining conditions (a feed rate and a rotation number of a spindle) of a complex lathe turning cycle instruction according to a program performed by the numerical controller, the numerical controller performs the machine learning of the combination of a machining path and machining conditions by which it is possible to reduce cycle time while maintaining machining quality to be able to automatically calculate a machining path and machining conditions most suitable for machining a workpiece.

Hereinafter, a description will be briefly given of the machine learning to be introduced into the present invention.

(1) Machine Learning

Here, machine learning will be briefly described. The machine learning is realized in such a way that useful rules, knowledge expressions, determination criteria, or the like are extracted by analysis from sets of data input to a device that performs the machine learning (hereinafter called a machine learning device), determination results of the extraction are output, and learning of knowledge is performed. Although machine learning is performed according to various methods, the methods are roughly classified into “supervised learning,” “unsupervised learning,” and “reinforcement learning.” In addition, in order to realize such methods, there is a method called “deep learning” by which to learn the extraction of feature amounts per se.

The “supervised learning” is a model by which sets of input and result (label) data are given to a machine learning device in large amounts to learn the features of the data sets and estimate results from inputs, i.e., a method by which the relationship between inputs and results may be inductively obtained. The method may be realized using an algorithm such as a neural network that will be described later.

The “unsupervised learning” is a learning method by which a device that learns, with the reception of only large amounts of input data, as to how the input data is distributed and applies compression, classification, shaping, or the like to the input data even if corresponding supervised output data is not given. The features of the data sets can be arranged in clusters each having similar characteristic in common. Using the results, any standard is set to allocate outputs so as to be optimized. Thus, the prediction of the outputs may be realized. In addition, as an intermediate problem setting between the “unsupervised learning” and the “supervised learning”, there is a method called “semi-supervised learning” in which some parts are exclusively given sets of input and output data while the other parts are given only input data. In an embodiment, since data that may be acquired even if a machining machine does not actually operate is used in the unsupervised learning, efficient learning is allowed.

The “reinforcement learning” is a method by which to learn not only determinations or classifications but also actions to perform learning of optimum actions in consideration of interactions given to environments by actions, i.e., learning to maximize rewards that will be obtained in the future. In the reinforcement learning, a machine learning device may start learning in a state in which the machine learning device does not completely know or imperfectly knows results brought about by actions. In addition, a machine learning device may start learning from a desirable start point in an initial state in which prior learning (a method such as the above supervised learning and inverse reinforcement learning) is performed in such as way as to imitate human's actions.

Note that when machine learning is applied to a machining machine, it is necessary to consider the fact that results may be obtained as data only after the machining machine actually operates, i.e., searching of optimum actions is performed by a trial and error approach. In view of the above circumstances, the present invention employs, as the principal learning algorithm of a machine learning device, the algorithm of reinforcement learning by which the machine learning device is given rewards to automatically learn actions to achieve a goal.

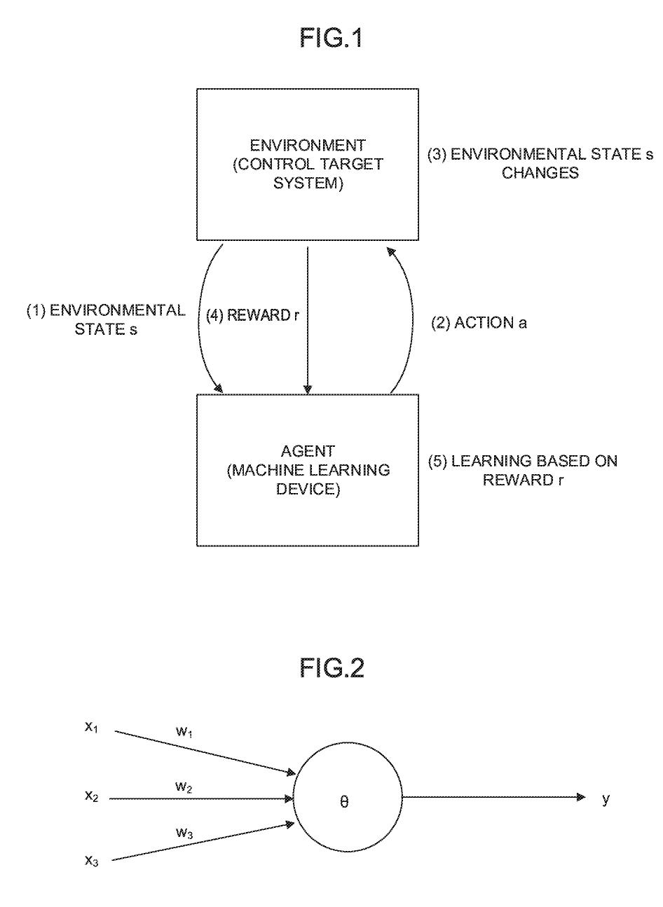

FIG. 1 is a diagram for describing the basic concept of a reinforcement learning algorithm.

In reinforcement learning, by an interactions between an agent (machine learning device) acting as a learning subject and an environment (control target system) acting as a control target, learning and action of the agent are advanced. More specifically, the following interactions are performed between the agent and the environment.

(1) The agent observes an environmental condition sₜ at a certain time.

(2) Based on an observation result and past learning, the agent selects and performs an action aₜ that the agent is allowed to take.

(3) The environmental condition sₜ changes to a next state sₜ₊₁ based on any rule and performance of the action aₜ.

(4) The agent accepts a reward rₜ₊₁ based on the state change as a result of the action aₜ.

(5) The agent advances the learning based on the state sₜ, the action aₜ, the reward rₜ₊₁, and a past learning result.

At the initial stage of the reinforcement learning, the agent does not understand the standard of a value judgment for selecting the optimum action aₜ with respect to the environmental condition sₜ in the above action selection (2). Therefore, the agent selects various actions aₜ in a certain state sₜ and learns the selection of a better action, i.e., the standard of an appropriate value judgment based on rewards rₜ₊₁ given with respect to the actions aₜ at that time.

In the above learning (5), the agent acquires the mapping of an observed state sₜ, an action aₜ, and a reward rₜ₊₁ as reference information for determining an amount of a reward that the agent is allowed to obtain in the future. For example, when the number of states that the agent is allowed to have at each time is m and the number of actions that the agent is allowed to take is n, the agent obtains a two-dimensional arrangement of m×n, in which rewards rₜ₊₁ corresponding to pairs of states sₜ and actions aₜ are stored, by repeatedly performing actions.

Then, with a value function (evaluation function) indicating to what degree a state or an action selected based on the above acquired mapping is valuable, the agent updates the value function (evaluation function) while repeatedly performing actions to learn an optimum action corresponding to a state.

A “state value function” is a value function indicating to what degree a certain state sₜ is valuable. The state value function is expressed as a function using a state as an argument and updated based on a reward obtained with respect to an action in a certain state, a value of a future state that transitions according to the action, or the like in learning in which actions are repeated. The update formula of the state value function is defined according to a reinforcement learning algorithm. For example, in temporal-difference (TD) learning indicating as one of reinforcement learning algorithms, the state value function is updated by the following formula (1). Note that in the following formula (1), α is called a learning coefficient, γ is called a discount rate, and the learning coefficient and the discount rate are defined to fall within 0<α≤1 and 0<γ≤1, respectively.

V(sₜ)←V(sₜ)+α[rₜ₊₁+γV(sₜ₊₁)−V(sₜ)]

In addition, an “action value function” is a value function indicating to what degree an action aₜ is valuable in a certain state sₜ. The action value function is expressed as a function using a state and an action as arguments and updated based on a reward obtained with respect to an action in a certain state, an action value of a future state that transitions according to the action, or the like in learning in which actions are repeated. The update formula of the action value function is defined according to a reinforcement learning algorithm. For example, in Q-learning indicating as one of typical reinforcement learning algorithms, the action value function is updated by the following formula (2). Note that in the following formula (2), α is called a learning coefficient, γ is called a discount rate, and the learning coefficient and the discount rate are defined to fall within 0<α≤1 and 0<γ≤1, respectively.

$$Q ( {s}_{t} , {a}_{t} ) ← Q ( {s}_{t} , {a}_{t} ) + α ( {r}_{t + 1} + γ {max}_{a} Q ( {s}_{t + 1} , a ) - Q ( {s}_{t} , {a}_{t} ) ) \qquad ( 2 )$$

The above formula expresses a method for updating an evaluation value Q(sₜ, aₜ) of an action aₜ in a state sₜ based on a reward rₜ₊₁ returned as a result of the action aₜ. It is indicated by the formula that Q(sₜ, aₜ) is increased if an evaluation value Q(sₜ+1, max(a)) of the best action max(a) in a next state as a result of the reward rₜ₊₁ and the action aₜ is greater than the evaluation value Q(sₜ, aₜ) of the action aₜ in the state sₜ, while Q(sₜ, aₜ) is decreased if not. That is, a value of a certain action in a certain state is made closer to a value of a reward immediately returned as a result of the action and the best action in a next state accompanied by the action.

In Q-learning, such an update is repeatedly performed to finally set Q(sₜ, aₜ) at an expected value E(Σγ^{t}rₜ) (the expected value is one taken when a state is changed according to an optimum action. Since the expected value is unknown as a matter of course, it is necessary to learn the expected value by search.).

Further, in the above action selection (2), an action aₜ by which a reward (rₜ₊₁+rₜ₊₂+ . . . ) over a future becomes maximum in a current state sₜ (an action for changing to a most valuable state in case where a state value function is used, or a most valuable action in the state in case where an action value function is used) is selected using a value function (evaluation function) generated by past learning. Note that during learning, an agent may select a random action with a constant probability for the purpose of advancing the learning in the selection of an action in the above action selection (2) (ε greedy method).

Note that in order to store a value function (evaluation function) as a learning result, there are a method for retaining values of all the pairs (s, a) of states and actions in a table form (action value table) and a method for preparing a function for approximating the above value function. According to the latter method, the above update formula may be realized by adjusting parameters of an approximate function based on a method such as method for probabilistic gradient descent. For the approximate function, a supervised learning device such as a neural network may be used.

The neural network is constituted by a calculation unit, a memory, and the like that realize a neural network following a neuron model as shown in, for example, FIG. 2. FIG. 2 is a schematic diagram showing a neuron model.

As shown in FIG. 2, a neuron outputs an output y with respect to a plurality of inputs x (here, inputs x₁ to x₃ as an example). A corresponding weight w (w₁ to w₃) is placed on each of the inputs x₁ to x₃. Thus, the neuron outputs the output y expressed by the following formula (3). Note that in the following formula (3), an input x, an output y, and a weight w are all vectors. In addition, θ indicates a bias, and fₖ indicates an activation function.

y=fₖ(Σᵢ₌₁ⁿxᵢwᵢ−θ) (3)

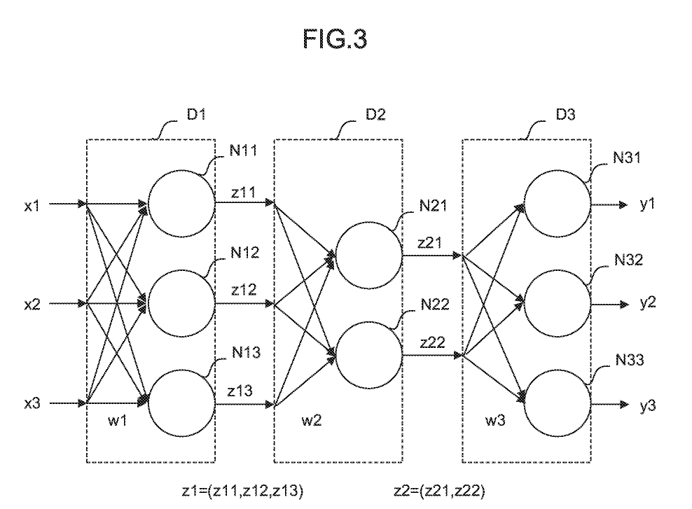

Next, a description will be given, with reference to FIG. 3, of a neural network having weights of three layers in which the above neurons are combined together.

FIG. 3 is a schematic diagram showing a neural network having weights of three layers D1 to D3. As shown in FIG. 3, a plurality of inputs x (here, inputs x1 to x3 as an example) is input from the left side of the neural network, and results y (here, results y1 to y3 as an example) are output from the right side of the neural network.

Specifically, when inputs x1 to x3 are input to three neurons N1 to N13, corresponding weights are placed on the inputs x1 to x3. The weights placed on the inputs are collectively indicated as w1. The neurons N1 to N13 output z11 to z13, respectively. Z11 to Z13 are collectively indicated as a feature vector z1, and may be regarded as vectors obtained by extracting feature amounts of the input vectors. The feature vector z1 is a feature vector between the weight w1 and a weight w2.

When z11 to z13 are input to two neurons N21 and N22, corresponding weights are placed on these z11 to z13. The weights placed on the feature vectors are collectively indicated as w2. The neurons N21 and N22 output z21 and z22, respectively. z21 and z22 are collectively indicated as a feature vector z2. The feature vector z2 is a feature vector between the weight w2 and a weight w3.

When the feature vectors z21 and z22 are input to three neurons N31 to N33, corresponding weights are placed on these feature vectors z21 and z22. The weights placed on the feature vectors are collectively indicated as w3.

Finally, the neurons N31 to N33 output the results y1 to y3, respectively.

The operation of the neural network includes a learning mode and a value prediction mode. A learning data set is used to learn the weight w in the learning mode, and the parameters are used to determine the action of a machining machine in the prediction mode (here, “prediction” is only for the sake of convenience, but various tasks such as detection, classification, and deduction may be included).

It is possible to immediately learn data obtained when a machining machine actually operates in the prediction mode and reflect the learning data on a next action (online learning), or is possible to perform collective learning using a previously-collected data group and thereafter perform a detection mode using the parameters at all times (batch learning). It is also possible to perform an intermediate mode, i.e., a learning mode that is performed every time data is accumulated by a certain degree.

Learning of the weights w1 to w3 is made possible by error back propagation. Error information enters from the right side and flows to the left side. The error back propagation is a method for adjusting (learning) each of the weights to reduce a difference between the output y obtained when the input x is input and a real output y (supervised) for each of the neurons.

The neural network may have three or more layers (called deep learning). It is possible to automatically obtain a calculation unit that extracts the features of inputs on a step-by-step basis and performs the regression of a result only from supervised data.

When such a neural network is used as an approximate function, the above value function (evaluation function) may be stored as the neural network to advance learning while the above actions (1) to (5) in the above reinforcement learning is repeatedly performed.

Generally, a machine learning device may advance learning to be adapted to a new environment by performing additional learning even when being put into the new environment after completing the learning in a certain environment. Accordingly, when the learning is applied to the adjustment of a machining path and machining conditions of a lathe turning cycle instruction in a numerical controller used to control a lathe machining machine to be adapted to new machining preconditions as in the present invention, additional learning under new machining preconditions may be performed based on the learning of the adjustment of a past machining path and machining conditions, with the result that it becomes possible to perform the learning of the adjustment of a machining path and machining conditions in a short time.

In addition, reinforcement learning employs a system in which a plurality of agents is connected to each other via a network or the like, and information on states s, actions a, rewards r, or the like is shared between the agents and applied to each learning, whereby each of the agents performs dispersed reinforcement learning in consideration of the environments of the other agents to be able to perform efficient learning. In the embodiment of the present invention as well, a plurality of agents (machine learning devices) incorporated in a plurality of environments (numerical controllers of lathe machining machines) performs dispersed machine learning in a state of being connected to each other via a network or the like, whereby the numerical controllers of the lathe machining machines are allowed to efficiently perform the learning of the adjustment of a machining path and machining conditions of a lathe turning cycle instruction.

Note that although various methods such as Q-learning, an SARSA method, TD learning, and an AC method have been commonly known as reinforcement learning algorithms, any of the above reinforcement algorithms may be applied to the present invention. Since each of the reinforcement learning algorithms has been commonly known, its detailed description will be omitted in the specification.

Hereinafter, a description will be given, based on a specific embodiment, of the numerical controller of a lathe machining machine according to the present invention into which a machine learning device is introduced.

### 2. Embodiment

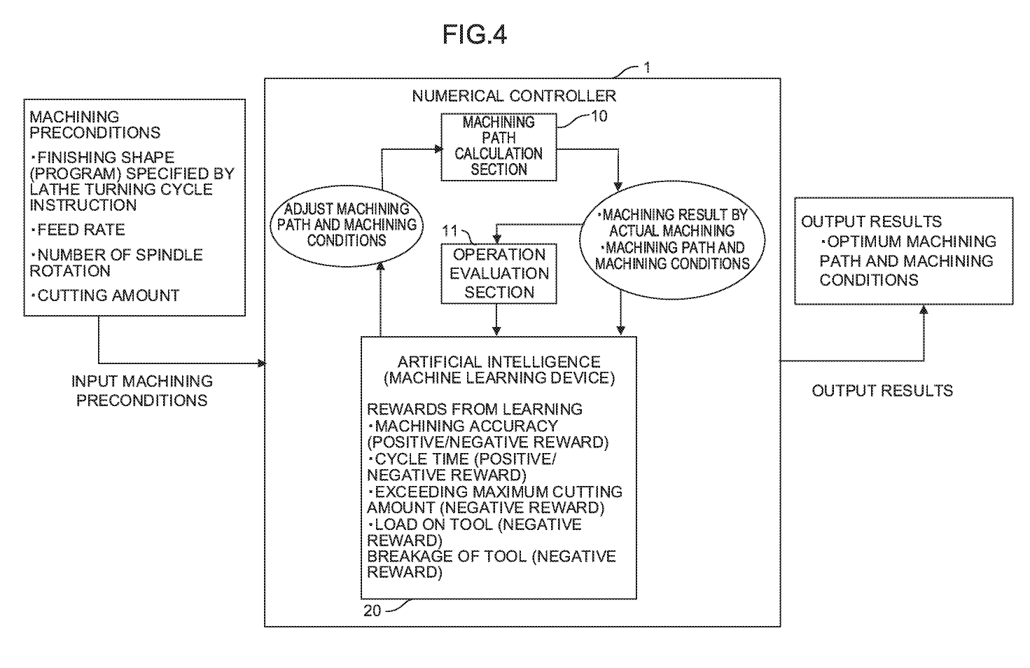

FIG. 4 is a diagram showing an image on the machine learning of the adjustment of a machining path and machining conditions of a lathe turning cycle instruction in the numerical controller of a lathe machining machine according to an embodiment of the present invention into which a machine learning device is introduced. Note that FIG. 4 shows only configurations necessary for describing the machine learning in the numerical controller of the lathe machining machine according to the embodiment.

In the embodiment, as information for specifying an environment (state sₜ described in the above “1. Machine Learning”) with a machine learning device 20, a machining path and machining conditions for a finishing shape based on machining preconditions determined by a numerical controller 1 are input to the machine learning device 20 as state information. For the machining path, the machining orders of pocket shapes and cutting amounts of respective pockets that will be described later are used to make the learning easy.

In the embodiment, an adjustment action for adjusting a machining path and machining conditions is output as an action (action aₜ described in the above “1. Machine Learning”) output by the machine learning device 20 to an environment.

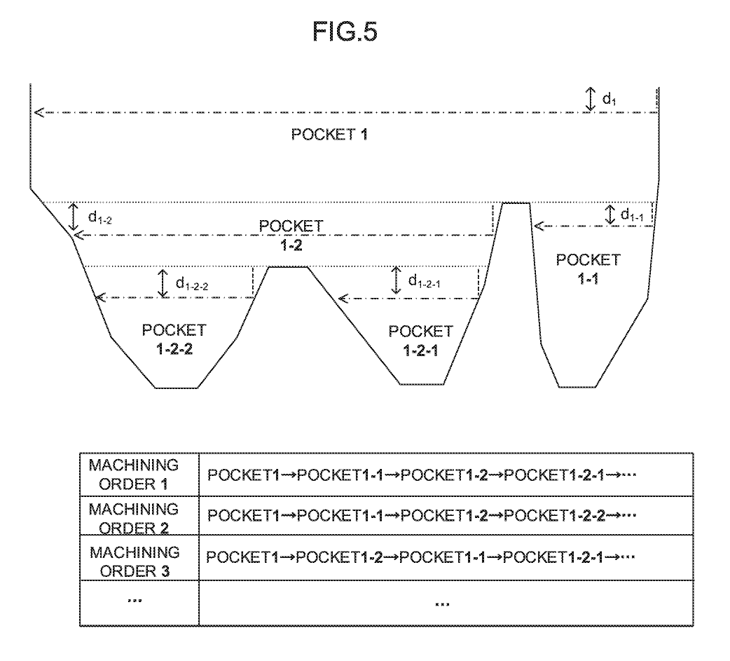

In the numerical controller 1 according to the embodiment, the above state information is defined by the states such as machining orders of pocket shapes, cutting amounts of respective pockets, a feed rate of a spindle when a turning cycle operation is performed by the lathe machining machine, and a rotation number of the spindle. The machining orders of the pocket shapes and the cutting amounts of the respective pockets when the turning cycle operation is performed are used to determine the machining path. As shown in FIG. 5, the machining orders of the pocket shapes when the turning cycle operation is performed are defined as the machining orders of the pocket shapes grasped from a finishing shape instructed by a lathe turning cycle instruction. Further, as shown in FIG. 5, the cutting amounts of the respective pockets may be defined as cutting amounts d₁ to d₁₋₂₋₂. The respective pockets are machined at the defined cutting amounts or less. Further, the above adjustment action may be defined by the selection of an adjustment target of the above values output from the machine learning device 20 and adjustment amounts of the values.

In addition, in the embodiment, machining accuracy (positive/negative reward), cycle time (positive/negative reward), or the like is employed as a reward (reward rₜ described in the above “1. Machine Learning”) to be provided to the machine learning device 20. Note that the determination of a reward based on any data may be appropriately set by an operator.

Moreover, in the embodiment, the machine learning device 20 performs the machine learning based on the above state information (input data), the adjustment action (output data), and the reward. In the machine learning, a state sₜ is defined by the combination of state data at certain time t, the determination of an adjustment operation for adjusting a machining path and machining conditions according to the defined state sₜ is equivalent to an action aₜ, and adjustment of a machining path and machining conditions is determined based on the action aₜ, machining of next workpiece is performed based on the determined adjustment of machining path and machining conditions, and a value calculated based on the data obtained as a result of such machining is equivalent to a reward rₜ₊₁. As described in the above “1. Machine Learning,” a state sₜ, an action aₜ, and a reward rₜ₊₁ are applied to the update formula of a value function (evaluation function) corresponding to a machine learning algorithm to advance the learning.

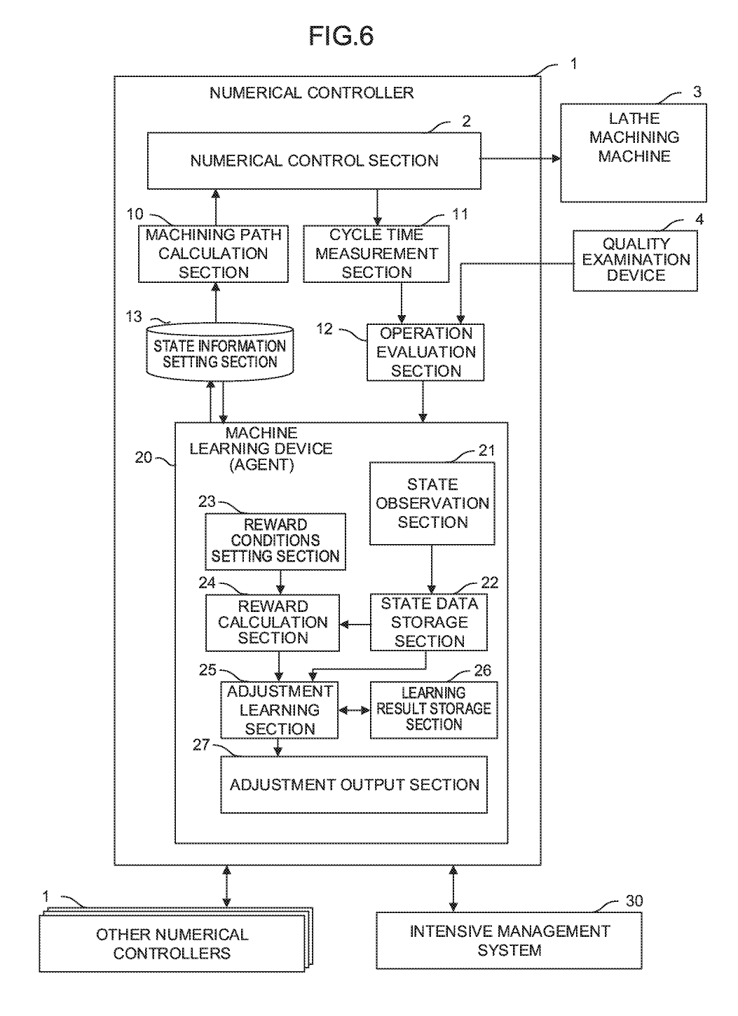

Hereinafter, a description will be given, with reference to the function block diagram of FIG. 6, of the numerical controller of the lathe machining machine according to the embodiment.

When the configurations of the numerical controller 1 shown in FIG. 6 are compared with the elements of the reinforcement learning shown in FIG. 1, the machine learning device 20 corresponds to the “agent” and a machining path calculation section 10, a cycle time measurement section 11, an operation evaluation section 12, and a state information setting section 13 correspond to the “environment.”

The numerical controller 1 of the lath machining machine according to the embodiment is an apparatus provided with the function of controlling a lathe machining machine 3 based on a program

The machining path calculation section 10 provided in the numerical controller 1 according to the embodiment calculates a machining path based on a program set in the state information setting section 13 by an operator, the machining orders of pocket shapes, and initial values of cutting amounts and machining conditions of respective pockets. When reading a general instruction from the program set in the state information setting section 13, the machining path calculation section 10 outputs the instruction to a numerical control section 2. In addition, when reading a lathe turning cycle instruction from the program set in the state information setting section 13, the machining path calculation section 10 analyzes the lathe turning cycle instruction to calculate a finishing shape, specifies pocket shapes included in the finishing shape, and machines the finishing shape according to the machining orders of the pocket shapes, the cutting amounts and the machining conditions of the respective pockets set in the state information setting section 13.

The calculation of a machining path by the machining path calculation section 10 may be performed using the method of a related art disclosed in, for example, Japanese Patent Application Laid-open No. 49-23385 described above. The machining path calculation section 10 is different from the related art in that the calculation of a machining path specifying the machining orders of pocket shapes and cutting amounts of respective pockets is allowed. The machining path calculation section 10 outputs an instruction for performing machining according to a calculated machining path to the numerical control section 2.

The numerical control section 2 analyzes an instruction received from the machining path calculation section 10 and controls the respective sections of the lathe machining machine 3 based on control data acquired as an analysis result. The numerical control section 2 is provided with functions necessary for performing general numerical control.

The cycle time measurement section 11 measures machining time (cycle time) required when the numerical control section 2 controls the lathe machining machine 3 based on an instruction received from the machining path calculation section 10 to machine a workpiece, and outputs the measured machining time to the operation evaluation section 12 that will be described later. The cycle time measurement section 11 may measure machining time using a timer (not shown) such as an RTC (Real-Time Clock) provided in the numerical controller 1.

The operation evaluation section 12 receives cycle time measured by the cycle time measurement section 11 and a result obtained when a quality examination device 4 examines the quality of a workpiece machined by the lathe machining machine 3 controlled by the numerical controller 2, and calculates an evaluation value for the received value.

Examples of an evaluation value calculated by the operation evaluation section 12 include “cycle time increases compared with machining based on the previous state information,” “cycle time decreases compared with machining based on the previous state information,” “cycle time does not change compared with machining based on the previous state information,” “the quality of a workpiece falls within a proper range (too good),” “the quality of a workpiece falls outside a proper range (too bad),” or the like.

The operation evaluation section 12 stores in advance workpiece quality (machining accuracy) serving as a reference for evaluating an operation and the records (cycle time and machining accuracy) of past machining results in a memory (not shown) provided in the numerical controller, and compares the stored past machining results with the stored workpiece quality serving as a reference to calculate the above evaluation value. Based on the records of machining results, the operation evaluation section 12 finds the convergence of evaluation (wherein cycle time and workpiece quality do not change, maintain their constant values, fluctuate between prescribed values in a past prescribed number of times), i.e., the operation evaluation section 12 recognizes that an optimum machining path and machining conditions at that point have been calculated and outputs a machining path and machining conditions currently set in the state information setting section 13 after instructing the machining path calculation section 10 and the machine learning device 20 to end a machine learning operation. In addition, when no convergence of an evaluation point is found, the operation evaluation section 12 outputs a calculated evaluation value to the machine learning device 20.

The machine learning device 20 that performs machine learning performs an adjustment operation for adjusting a machining path and machining conditions and the learning of the adjustment operation when a workpiece is machined by the lathe machining machine 3 under the control of the numerical control section 2 and an evaluation value is output by the operation evaluation section 12.

The machine learning device 20 that performs machine learning is provided with a state observation section 21, a state data storage section 22, a reward conditions setting section 23, a reward calculation section 24, an adjustment learning section 25, a learning result storage section 26, and an adjustment output section 27. The machine learning device 20 may be provided inside the numerical controller 1 as shown in FIG. 6, or may be provided in a personal computer or the like outside the numerical controller 1.

The state observation section 21 observes a machining path and machining conditions for machining set in the state information setting section 13 and an evaluation value output from the operation evaluation section 12 as state data and acquires the same inside the machine learning device 20.

The state data storage section 22 receives and stores state data observed by the state observation section 21 and outputs the stored state data to the reward calculation section 24 and the adjustment learning section 25. The state data input to the state data storage section 22 may be data acquired by the latest operation of the numerical controller 1 or data acquired by the past operation of the numerical controller 1. In addition, it is also possible for the state data storage section 22 to receive and store state data stored in other numerical controllers 1 or an intensive management system 30, or is possible for the state data storage section 22 to output state data stored in the state data storage section 22 to other numerical controllers 1 or the intensive management system 30.

The reward conditions setting section 23 sets and stores conditions for giving rewards in machine learning input by an operator or the like. Positive and negative rewards are provided and may be appropriately set. In addition, an input to the reward conditions setting section 23 may be performed via a personal computer, a tablet terminal, or the like used in the intensive management system 30. However, with an input via a MDI (Manual Data Input) apparatus (not shown) of the numerical controller 1, it becomes possible to more easily set conditions for giving rewards.

The reward calculation section 24 analyzes state data input from the state observation section 21 or the state data storage section 22 based on conditions set by the reward conditions setting section 23, and outputs calculated rewards to the adjustment learning section 25.

Hereinafter, a description will be given of an example of reward conditions set by the reward conditions setting section 23 in the embodiment.

Reward 1: Machining Accuracy (Positive/Negative Reward)

When machining accuracy falls within a proper range set in advance in the numerical controller 1, a positive reward is provided. On the other hand, when the machining accuracy falls outside the proper range set in advance in the numerical controller 1 (when the machining accuracy is too bad or too good), a negative reward is provided according to the degree. Note that as for giving a negative reward, a large negative reward may be provided when the machining accuracy is too bad and a small negative reward may be provided when the machining accuracy is too good.

Reward 2: Cycle Time (Positive/Negative Reward)

When cycle time does not change, a small negative reward is provided. When the cycle time decreases, a positive reward is provided according to the degree. On the other hand, when the cycle time increases, a negative reward is provided according to the degree.

Reward 3: Exceeding Maximum Cutting Amount (Negative Reward)

When a cutting amount with a tool exceeds a maximum cutting amount defined in the lathe machining machine, a negative reward is provided according to the degree.

Reward 4: Load on Tool (Negative Reward)

When a load on a tool during cutting with the tool exceeds a prescribed value, a negative reward is provided according to the degree.

Reward 5: Breakage of Tool (Negative Reward)

When a tool is broken during machining and thus replaced, a large negative reward is provided.

The adjustment learning section 25 performs machine learning (reinforcement learning) based on state data input from the state observation section 21 or the state data storage section 22, adjustment results of a machining path and machining conditions performed by the adjustment learning section 25 itself, and a reward calculated by the reward calculation section 24.

Here, in the machine learning performed by the adjustment learning section 25, a state sₜ is defined by the combination of state data at certain time t, and the determination of an adjustment operation for adjusting a machining path and machining conditions according to the defined state sₜ is equivalent to an action aₜ. Then, the adjustment of a machining path and machining conditions is determined by the adjustment output section 27 that will be described later, and based on the adjustment of the determined machining path and the machining conditions, a machining path and machining conditions stored in the state information setting section 13 are adjusted. Then, based on the settings of the new machining path and the machining conditions, the numerical control section 2 perform the machining of a next workpiece. A value calculated by the reward calculation section 24 based on resultant data (an output from the operation evaluation section 12) is equivalent to a reward rₜ₊₁. A value function used in the learning is determined according to an applied learning algorithm. For example, when Q-learning is used, it is only necessary to update an action value function Q(sₜ, aₜ) according to the above formula (2) to advance the learning.

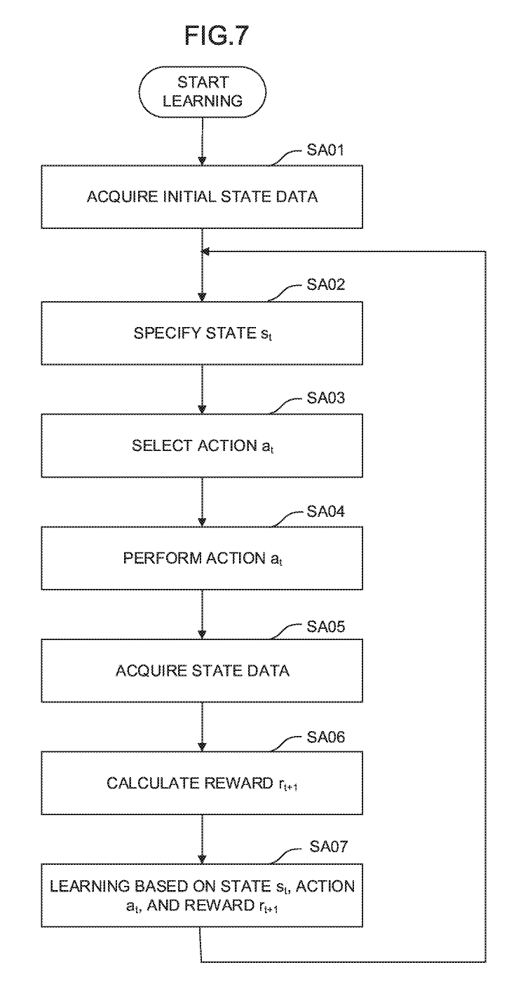

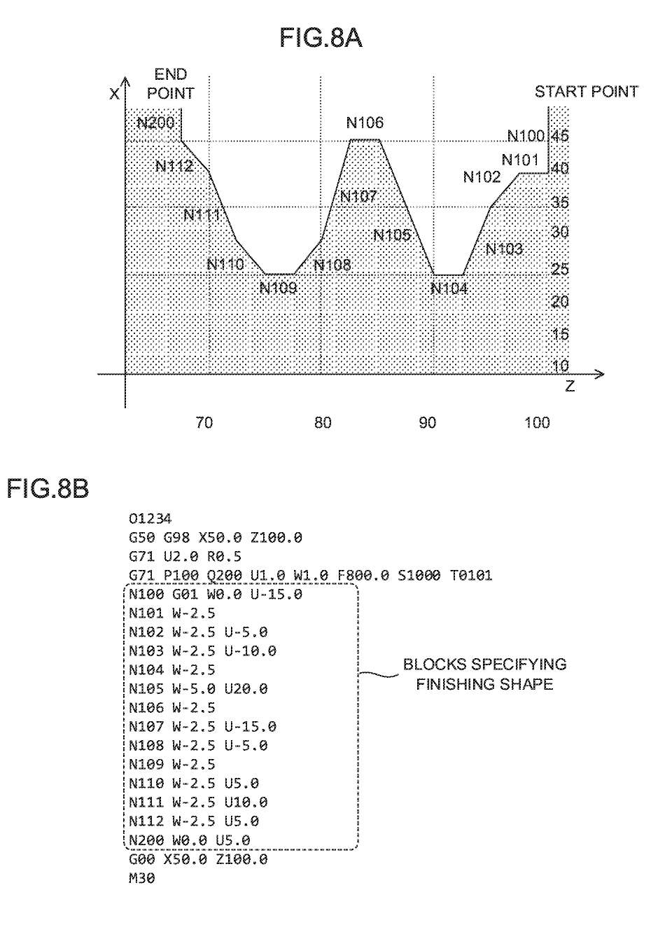

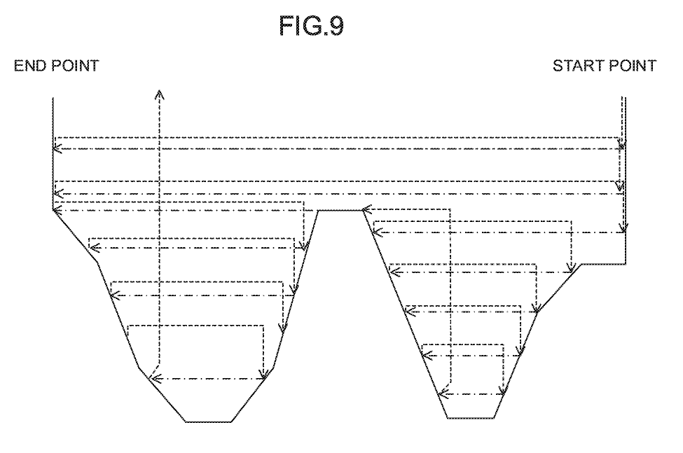

A description will be given, with reference to the flowchart of FIG. 7, of the flow of machine learning performed by the adjustment learning section 25.

Hereinafter, the description will be given in line with each step of the flowchart.

Step SA01. When the machine learning starts, the state observation section 21 acquires state data on the numerical controller 1.

Step SA02. The adjustment learning section 25 specifies a current state sₜ based on the state data acquired by the state observation section 21.

Step SA03. The adjustment learning section 25 selects an action aₜ (adjustment of a machining path and machining conditions) based on a past learning result and the state sₜ specified in step SA02.

Step SA04. The action aₜ selected in step SA03 is performed.

Step SA05. The state observation section 21 acquires data output from the operation evaluation section 12 (and a machining path and machining conditions set in the state information setting section 13) as state data on the numerical controller 1. At this stage, the state of the numerical controller 1 changes with a temporal transition from time t to time t+1 as a result of the action aₜ performed in step SA04.

Step SA06. The reward calculation section 24 calculates a reward rₜ₊₁ based on the state data acquired in step SA05.

Step SA07. The adjustment learning section 25 advances the machine learning based on the state sₜ specified in step SA02, the action aₜ selected in step SA03, and the reward rₜ₊₁ calculated in step SA06 and then the processing returns to step SA02.

Referring back to FIG. 6, the learning result storage section 26 stores a learning result learned by the adjustment learning section 25. Further, when a learning result is used by the adjustment learning section 25 again, the learning result storage section 26 outputs a stored learning result to the adjustment learning section 25. As described above, a learning result may be stored in such a way that a value function corresponding to a machine learning algorithm to be used is stored in a supervised learning device such as an SVM (Support Vector Machine) and a neural network of an approximate function, an arrangement, or a multiple-value output, or the like.

Note that it is also possible for the learning result storage section 26 to receive and store a learning result stored in other numerical controllers 1 or the intensive management system 30, or is possible for the learning result storage section 26 to output a learning result stored in the learning result storage section 26 to other numerical controllers 1 or the intensive management system 30.

Based on a learning result by the adjustment learning section 25 and current state data, the adjustment output section 27 determines the adjustment target of a machining path and machining conditions and adjustment amounts of the machining path and the machining conditions. Here, the determination of the adjustment target of a machining path and machining conditions and adjustment amounts of the machining path and the machining conditions is equivalent to an action a used in machine learning. The adjustment of a machining path and machining conditions may be performed in such a way that selection as to which one of a machining path (machining orders of pocket shapes, cutting amounts of respective pockets), a feed rate, and a rotation number of a spindle is adjusted and an adjustment degree of a selected adjustment target are combined together, respective combinations are prepared as selectable actions (for example, an action 1=the machining order of the pockets is changed to the next lower order shown in FIG. 5, an action 2=the feed rate is increased by +10 mm/m, an action 3=the rotation number of the spindle is increased by +100 mm/m, an action 4=the cutting amounts of the pockets 1 are increased by +1 mm, . . . ), and an action by which the largest reward will be obtained in the future based on a past learning result is selected. The selectable actions may be actions by which a plurality of machining conditions is simultaneously adjusted. In addition, the above ε greedy method may be employed to select a random action with a constant probability for the purpose of advancing the learning of the adjustment learning section 25.

Then, the adjustment output section 27 adjusts a machining path and machining conditions set in the state information setting section 13 based on the adjustment of a machining path and machining conditions determined by the selection of an action.

Then, as described above, the machining path calculation section 10 calculates a machining path based on the machining path and the machining conditions set in the state information setting section 13. The numerical control section 2 controls the lathe machining machine to machine a workpiece based on the calculated machining path, the operation evaluation section 12 calculates an evaluation value, the state observation section 21 acquires data on a situation, and machine learning is repeatedly performed. Thus, the acquisition of a more excellent learning result is made possible.

When the lathe machining machine is actually operated using learning data for which the learning has been completed, the machine learning device 20 may be attached to the numerical controller 1 so as not to perform new learning and operated using the learning data for which the learning has been completed as it is.

In addition, the machine learning device 20 having completed learning (or the machine learning device 20 in which completed learning data on other machine learning devices 20 has been copied in the learning result storage section 26) may be attached to other numerical controllers and operated using the learning data for which the learning has been completed as it is.

Further, the machine learning device 20 of the numerical controller 1 may perform machine learning alone. However, when each of a plurality of numerical controllers 1 is further provided with a section used to communicate with an outside, it becomes possible to send/receive and share state data stored in each of the state data storage sections 22 and a learning result stored in each of the learning result storage sections 26. Thus, more efficient machine learning is allowed. For example, learning is advanced in parallel between a plurality of numerical controllers 1 in such a way that state data and learning data are exchanged between the numerical controllers 1 while adjustment targets and adjustment amounts different between the numerical controllers 1 are fluctuated within a prescribed range. Thus, efficient learning is allowed.

In order to exchange state data and learning data between a plurality of numerical controllers 1 as described above, communication may be performed via a host computer such as the intensive management system 30, the numerical controllers 1 may directly communicate with each other, or a cloud may be used. However, for handling large amounts of data, a communication section with a faster communication speed is preferably provided.

The embodiment of the present invention is described above. However, the present invention is not limited only to the example of the above embodiment and may be carried out in various aspects with appropriate modifications.

1. A numerical controller controlling a lathe machining machine based on a lathe turning cycle instruction instructed by a program to machine a workpiece, the numerical controller comprising:
a state information setting section in which a machining path and machining conditions of the lathe turning cycle instruction are set;
a machining path calculation section that calculates the machining path based on setting of the state information setting section and the lathe turning cycle instruction;
a numerical control section that controls the lathe machining machine according to the machining path, calculated by the machining path calculation section, to machine the workpiece;
an operation evaluation section that calculates an evaluation value used to evaluate cycle time required for machining the workpiece performed according to the machining path calculated by the machining path calculation section and machining quality of the workpiece machined according to the machining path calculated by the machining path calculation section; and
a machine learning device that performs machine learning of adjustment of the machining path and the machining conditions, wherein
the machine learning device has
a state observation section that acquires the machining path and the machining conditions stored in the state information setting section and the evaluation value, as state data,
a reward conditions setting section that sets reward conditions,
a reward calculation section that calculates a reward based on the state data and the reward conditions,
an adjustment learning section that performs machine learning of the adjustment of the machining path and the machining conditions, and
an adjustment output section that determines an adjustment target and adjustment amounts of the machining path and the machining conditions as an adjustment action based on state data and a result of the machine learning of the adjustment of the machining path and the machining conditions by the adjustment learning section and adjusts the machining path and the machining conditions set in the state information setting section based on a result of the determination, wherein
the machining path calculation section recalculates and outputs the machining path based on the machining path and the machining conditions adjusted by the adjustment output section and set in the state information setting section, and
the adjustment learning section performs the machine learning of the adjustment of the machining path and the machining conditions based on the adjustment action, the state data acquired by the state observation section after the machining of the workpiece based on the machining path recalculated by the machining path calculation section, and the reward calculated by the reward calculation section based on the state data.

2. The numerical controller according to claim 1, further comprising:
a learning result storage section that stores the result of learning by the adjustment learning section, wherein
the adjustment output section adjusts the machining path and the machining conditions based on the result of the learning of the adjustment of the machining path and the machining conditions by the adjustment learning section and the result of the learning of the adjustment of the machining path and the machining conditions stored in the learning result storage section.

3. The numerical controller according to claim 1, wherein
the reward conditions are set such that
a positive reward is provided when the cycle time decreases, the cycle time does not change, or the machining quality is within a proper range, and
a negative reward is provided when the cycle time increases or the machining quality is outside the proper range.

4. The numerical controller according to claim 1, which is connected to at least one of other numerical controllers and mutually exchanges or shares the result of the machine learning with the at least one of other numerical controllers.

5. A machine learning device performing machine learning of adjustment of a machining path and machining conditions of a lathe turning cycle instruction when controlling a lathe machining machine based on the lathe turning cycle instruction instructed by a program to machine a workpiece,
the machine learning device comprising:
a state observation section that acquires the machining path and the machining conditions as state data;
a reward conditions setting section that sets reward conditions;
a reward calculation section that calculates a reward based on the state data and the reward conditions;
an adjustment learning section that performs the machine learning of the adjustment of the machining path and the machining conditions; and
an adjustment output section that determines an adjustment target and adjustment amounts of the machining path and the machining conditions as an adjustment action based on the state data and a result of the machine learning of the adjustment of the machining path and the machining conditions by the adjustment learning section and adjusts the machining path and the machining conditions based on a result of the determination, wherein
the adjustment learning section performs the machine learning of the adjustment of the machining path and the machining conditions based on the adjustment action, the state data acquired by the state observation section after the machining of the workpiece based on the machining path recalculated after the adjustment action, and the reward calculated by the reward calculation section based on the state data.
